(19) United States
(12) Patent Application Publication
(10) Pub. No.: US 2020/0143381 A1
(43) Pub. Date: May 7, 2020

(54) System and Method for Obtaining a Temporary CVV using Tokenization Rails

(71) Applicant: PayPal, Inc., San Jose, CA (US)

(72) Inventors: Abhishek Chhibber, Sunnyvale, CA (US); Kishore Jaladi, Campbell, CA (US)

(73) Assignee: PayPal, Inc.

(21) Appl. No.: 16/182,319

(22) Filed: Nov. 6, 2018

(51) Int. Cl. G06Q 20/40; G06Q 20/38; G06Q 20/32

(52) U.S. Cl. CPC G06Q 20/4018; G06Q 20/322; G06Q 20/385

(57) ABSTRACT

Aspects of the present disclosure involve systems, methods, devices, and the like for performing electronic transactions. In one embodiment, a system and method are introduced which enable the use of a temporary notification for use in processing the electronic transaction. The temporary notification may arrive in the form a temporary CVV using tokenization rails and used for the verification and authorization of the electronic transaction.

### TECHNICAL FIELD

The present disclosure generally relates to communication devices for performing electronic transactions and more specifically, to communication devices that step-up authentication for electronic transactions.

### BACKGROUND

In the advent of technology, industry has moved to the use of electronic devices and communications for processing transactions. More recently, the use of electronic devices as digital wallets has grown. In some instances, credit cards and third-party payment providers can be added to the digital wallet and used for payment. However, although convenient, these types of payments may encounter a failure at the time of payment, if the transaction is flagged as too risky. Such failure can often cause frustration and can lead to an unsatisfactory consumer experience. Additionally, such failure also leads to an unpurchased product or service and thus, a loss of profit for the merchant. Therefore, it would be beneficial to create a system that provides an authentication notification that may be used to enable the processing of such risky or flagged transaction.

### BRIEF DESCRIPTION OF THE FIGURES

FIG. 1 illustrates an exemplary diagram illustrating a user device used in conjunction with a digital wallet for performing an electronic transaction.

FIG. 2 illustrates systems for performing an electronic transaction using credit card tokenization rails.

FIG. 3 illustrates a timing diagram of a communication between systems for obtaining a temporary CVV using tokenization rails for performing an electronic transaction.

FIG. 4 illustrates an exemplary user device engaged in an electronic transaction using a temporary CVV.

FIG. 5 illustrate flow diagrams illustrating operations for performing an electronic transaction using a temporary CVV.

FIG. 6 illustrates a block diagram of a system for obtaining a temporary CVV using tokenization rails.

FIG. 7 illustrates an example block diagram of a computer system suitable for implementing one or more devices of the communication systems of FIGS. 1-6.

Embodiments of the present disclosure and their advantages are best understood by referring to the detailed description that follows. It should be appreciated that like reference numerals are used to identify like elements illustrated in one or more of the figures, whereas showings therein are for purposes of illustrating embodiments of the present disclosure and not for purposes of limiting the same.

### DETAILED DESCRIPTION

In the following description, specific details are set forth describing some embodiments consistent with the present disclosure. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Aspects of the present disclosure involve systems, methods, devices, and the like for performing electronic transactions. In one embodiment, a system and method are introduced which enable the use of a temporary notification for use in processing the electronic transaction. The temporary notification may arrive in the form a temporary CVV using tokenization rails and used for the verification and authorization of the electronic transaction.

Rapid advances in communications have made portable electronic devices, such as smartphones and tablets, part of everyday life. Among other things, these electronic devices can be used to browse the web, stream video, and purchase goods and services. In some instances, one or more electronic devices can be used to make the purchase. Conventionally, electronic transactions or purchase may begin at a merchant site with a redirect to a secondary site based in part on the payment provider used. In some instances, a digital wallet may be used for checkout, in other instances, a credit card may be selected. While in other instances, a third-party payment provider may be the financial instrument of choice. Despite the instrument used, some electronic transactions may be considered suspicious, risky, unconventional, or meets a criteria. As such, secondary forms of user verification may be requested, step-up authentication, and/or a failed or block transaction will occur.

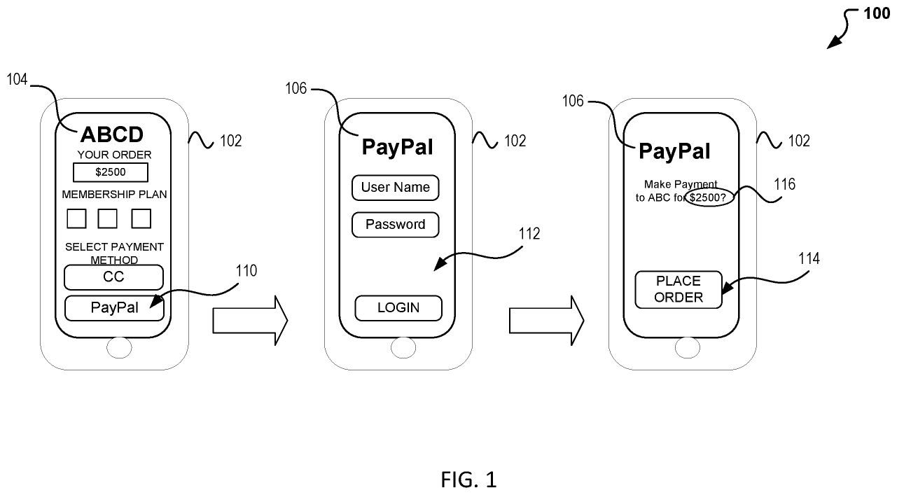

To overcome such failures, credit cards often rely on the use of a credit card verification value (CVV) printed on the back of the physical credit card. However, when another financial instrument that is not associated with the credit card is used, such verification and authentication mechanism may not be available. To illustrate this, consider FIG. 1, where a conventional method for performing one or more transactions is introduced and a user interacting with a user device 102 is presented. The user device 102 may be a tablet, iPad, cell phone, laptop, desktop, or the like. For exemplary purposes, user device 102 can be a smart phone. The smart phone may be equipped with various applications for performing numerous tasks including but not limited to web browsing, video streaming, bill pay, and purchase of goods and services.

In conventional method presented with FIG. 1, UI 104 of a merchant 104 is illustrated on the user device 102, wherein the user is at checkout 110 and ready to process a transaction. As illustrated using this method, a third-party provider 106 has been selected for checkout 110.

Notice that in such instance, a user may be redirected to a login site associated with the third-party provider 106 for login and payment processing. As illustrated, the user account may be confirmed, and login is achieved, however, upon login and prior to payment processing 114, the order may be flagged 116 and considered too risky for processing. As such, the transaction may be cancelled, blocked, or fail altogether. As indicated, credit cards provide a card verification code which can may be used for authentication and verification that indeed the purchase should be made. With the use of a third-party payment provider 106 however, may fail to provide such step-up authentication, purchase verification, card verification code, or the like to permit such purchase. Therefore, it would be beneficial to present a system that is able to provide a similar verification code.

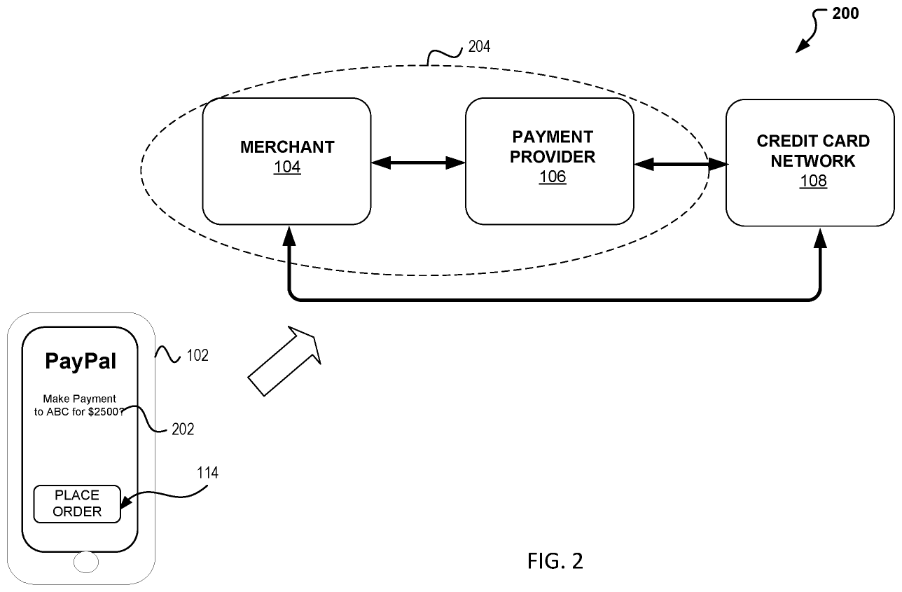

Turning to FIG. 2, a first embodiment is presented wherein a system and method are illustrated that enable to use and access of a temporary CVV code for the placement and processing of the order/transaction. In particular, FIG. 2 illustrates a system for performing an electronic transaction using credit card tokenization rails. Tokenization is a process for protecting and securing user data or other sensitive data with the use of an algorithm or encrypting mechanism which generates what is known as a token. This token is used to replace the user's secure information (e.g., in a credit card it replaces a customer's primary account number) into a randomly generated set of numbers. These numbers or token are thus passed and communicated between the various parties over a network to perform a transaction. Thus, a transaction may be processed without exposing a user's sensitive information.

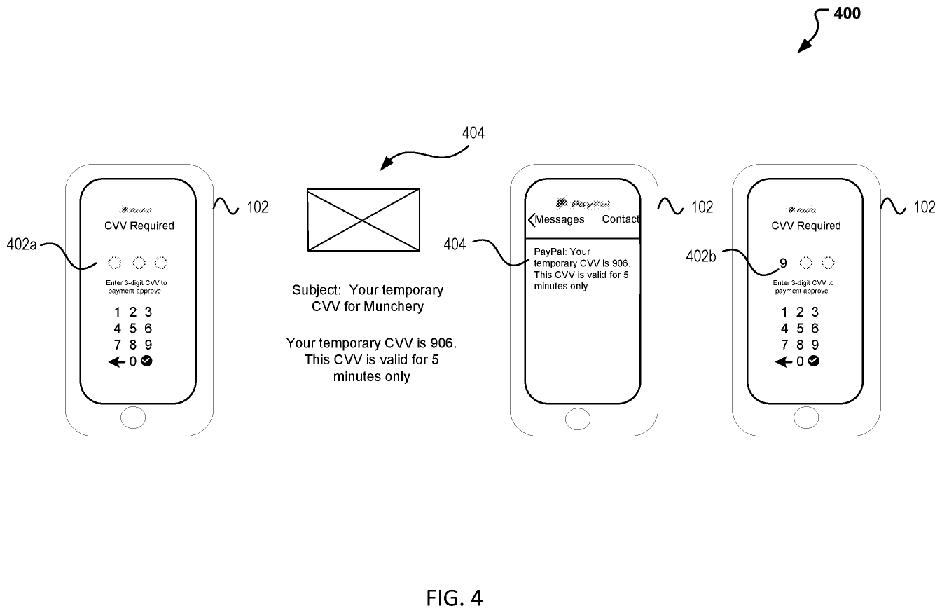

Illustrated in FIG. 2, is the user device 102 in preparation to process a transaction 114 for a transaction that may be considered risky 202. Generally, a request to process a transaction with a third-party payment provider (third-party payment application system) 106 (e.g., PayPal), would include a communication between the merchant (or product provider entity) 104 and the payment provider 106. An input received to place an order 114 would thus create a notification back to the payment provider 106 to process the $2500 payment as exemplified here. However, such a large amount may be flagged as unconventional by the user, or the purchase to large and considered risky. Thus, this type of request could lead to a failed or blocked transaction. Therefore, herein, a credit card network is introduced and included in the communication for processing the transaction. Thus, where conventionally, where a merchant 104 would communicate bi-directionally with the third-party payment provider 106 for payment and processing 204, instead, the credit card network 108 is being accessed and communicated with. The credit card network 108 is being used for communicating with the merchant in this case to provide a temporary CVV and exchange a token for user information verification and authentication. The use of the credit card network permits the introduction of a token as discussed above and further a temporary CVV for processing the transaction. To illustrate how the communication can occur between the three entities, FIG. 4 is introduced and described in detail below.

As indicated transactions that use a digital wallet and/or other digital service at a user device, for checkout may encounter a failure if the transaction is flagged as too risky. Therefore, as introduced a system and method is introduced that may be used to notify a user of such flagged transaction. The notification may arrive in the form of an authentication code such that a user may enter the code to authorize the transaction. In one embodiment, the system and method include the use of a temporary CVV for performing the electronic transaction.

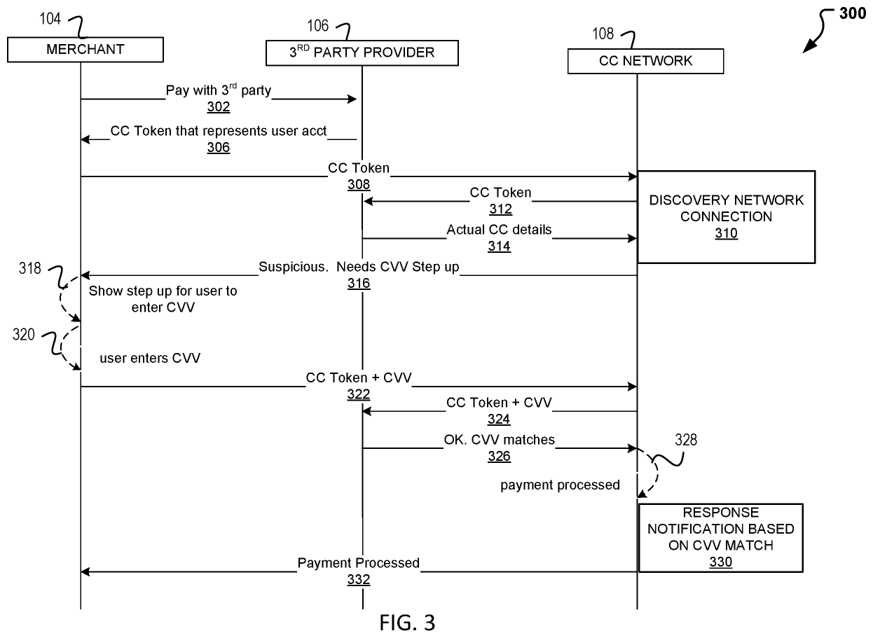

Turning to FIG. 3, a timing diagram 300 is presented which illustrates an exemplary communication between systems for obtaining the temporary CVV using tokenization rails for performing an electronic transaction. In the timing diagram 300, three systems communicating include a merchant 104, a third-party provider 106, and a credit card (CC) network 108. Illustrated in timing diagram 300 is an instance where a user may be checking out from a merchant 104 (or merchant site), similar to the user interface interaction illustrated above and in conjunction with FIG. 2. At checkout, the user may indicate a preference to checkout 302 or pay using or with a third-party provider 106. The third-party provider 106 may include an entity such as PayPal, where the account with PayPal is used to process the payment to the merchant 104. As such, in response to the request to pay with the third-party provider 106, a token may be exchanged with the merchant or transmitted to the merchant representing the user account associated with the user 306. In one embodiment, because the use of a temporary CVV is introduced, tokenization rails are used and as such, the token exchanged is a credit card token.

Following the receipt of the token by the merchant 104, the merchant 104 may then communicate with the credit card network 108 to obtain credit card details and in some instances the temporary CVV for flagged transactions 312. To obtain credit card details, a message may first be sent to the credit card network 108 with the token (e.g., CC token) 308 obtained from the third-party provider 106. Using the CC token received, the credit card network 108 works in discovery mode or as a discovery network connection 310 with the merchant wherein using the tokenization rails, the credit card network 108 is able to communicate 312 with third party provider 106 to obtain actual account details (including credit card information) 314 that may be used in processing the transaction and creating a temporary CVV. Therefore, using the account details, the CC token received 308 by the merchant 104 may be confirmed with those sent 312 to the third-party provider 106 to determine if the details match and if a suspicious transaction is occurring 316. The suspicious transaction may occur in instances where for example, the amount of the transaction is large, the token details do not match, the merchant is not recognized, the user device unknown, etc.

Thus, a notification from the credit card network 108 may be sent to the merchant 104 indicating that such transaction may necessitate the use of a temporary CVV 316. The merchant 104 may then such a notification for a user to set up/enter a temporary CVV 318. This notification may arrive at a user device 102 in the form of an email, SMS message, text, pop-up notification, at the third-party application UI, on the third-party site, etc. and provide the user at the device the ability to enter the temporary CVV 320 for processing of the transaction. Presented below and in conjunction with FIG. 4, an exemplary user device and user interfaces will be presented illustrating the notification, transmission, and receipt of the temporary CVV.

Continuing with timing diagram 300, once the temporary CVV is entered on the user interface of the user device 320, the temporary CVV along with initial CC token are transmitted 322 back to the credit card network 108 for confirmation, verification, and processing of the transaction. At the credit card network 308, a communication may occur with the third-party provider 106, where the message may include the CC token and temporary CVV information 324 received from the merchant 104. This message may present a request to the third-party provider 306 as a confirmation that indeed the details match those associated with the user account. If such agreement exists between the details (e.g., CC token and temporary CVV), then a response affirming this 326 is transmitted back from the third-party provider 106 to the credit card network 108, payment is processed 328, and notification of payment processed 332 is transmitted back to the merchant 104. Alternatively, if the CC token and temporary CVV do not match, then a response then be sent back to the merchant 104 indicating that a failure exists, and the payment may not be processed. Thus, at the merchant site 104 the user may be present with an indicating that the payment may not be processed and/or that the user details (e.g., temporary CVV) do not match.

Note that FIG. 3 is presented as an exemplary timing diagram 300 and more or less steps may exist. Further, the tokens and exchange of user details may vary, and other token details may be added or removed for the processing of the electronic transaction. Thus, other implementations for providing a temporary CVV may be contemplated. To illustrate how this type of temporary CVV may be presented to a user on a user device 102, FIG. 4 is presented. In particular, FIG. 4 illustrates an exemplary user device 102 engaged in an electronic transaction 400 using a temporary CVV. Thus, per timing diagram 300, illustrated at FIG. 4 is the electronic transaction at step 318, where a user request has been sent for the input of a CVV.

As an illustration, user device 102, wherein upon request to process a transaction which may have been flagged, a CVV UI 402a is presented prompting a request for an input of a temporary CVV. This CVV UI 402a may be a request for a 3-digit code similar to what is found on the back of a physical credit card. Thus, the temporary CVV may be a randomly generated three-digit number.

As indicated, in one embodiment, a temporary CVV is created herein using tokenization rails through the use of a credit card network 108 to function as a means for authenticating a user and processing an electronic transaction which may be flagged as suspicious or risky. To obtain the temporary CVV requested by the CVV UI 402a as prompted on the user device 102, a pop-up notification, email 404 transmission may be sent, SMS message 406, or other notification may be used for providing the user with the temporary CVV. As illustrated at FIG. 4, the temporary CVV may arrive in the form of an email notice 404 containing the 3-digit code, user information, as well as a time period indicating a time limit on using the temporary CVV provided. Additionally, or alternatively, the temporary CVV may be provided using a messaging system. The messaging system may be on a messenger application, as a message on the third-party provider 106, or using another messaging service. Illustrated at FIG. 4, is a messaging UI 406 illustrating a message containing the temporary CVV that may be presented for the user. In the message, as was the case with the email, a time limitation may be included as well as other user and useful information.

Upon receipt of the temporary CVV notification 404, 406, the user may return to the CVV UI 402b to input the temporary CVV provided. As illustrated on the CVV UI 402b, as provided by the notification, temporary CVV 906 is being input. Then, as indicated above and in conjunction with FIG. 3, the temporary CVV received in conjunction with the CC token are transmitted back to the credit card network 108 and third-party provider 106 to ensure a match exists and that indeed the electronic transaction may be processed. If a match does not exist, then a user may be presented with yet another UI (not shown) indicating that the CVV (or other information) did not match and/or that the transaction may not be processed.

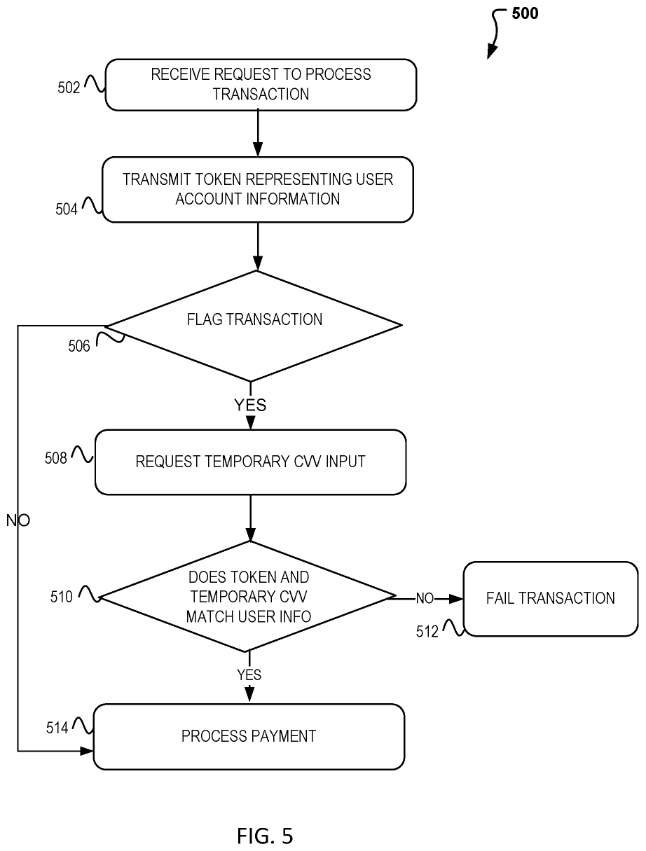

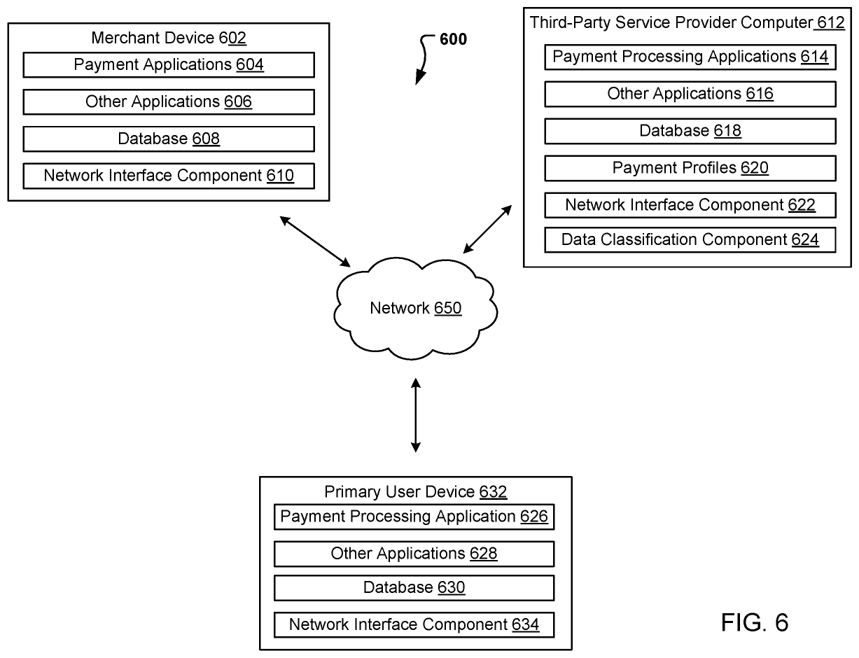

FIG. 5 illustrate example process 500 for obtaining a temporary CVV using tokenization rails and implemented by a system such as system 600 of FIG. 6 and/or timing diagram 300 of FIG. 3. In particular, FIG. 5 illustrates a flow diagram illustrating operations for executing a transaction using a temporary CVV.

In FIG. 5, according to some embodiments, process 500 may include one or more of operations 502-514, which may be implemented, at least in part, in the form of executable code stored on a non-transitory, tangible, machine readable media that, when run on one or more hardware processors, may cause a system to perform one or more of the operations 502-514.

Process 500 may begin with operation 502, where a request may be received from a merchant or other entity providing a service or product for the completion of an electronic transaction. As has been described, the request may derive from a merchant site, a merchant related application, or other communication wherein a user is attempting to process a payment. The processing of the payment may be associated with a digital wallet, financial institution or other third-party payment provider. In an exemplary example, the payment may be received by a third-party payment provider. In one embodiment, the third-party payment provider may be in association with a credit card network and as such may use tokenization rails for processing the payment request.

As a response to the payment request and transaction processing request, process 500 may continue to operation 504, wherein a token is transmitted to the merchant or requesting entity. The token may be a randomly generated number which is used to represent the user account information. In one embodiment, the third-party payment provider, may transmit a credit card token associated with the user primary account. Once the token has been received by the entity/merchant, the merchant may then communicate directly with the credit card network for the payment request. The credit card network, may therefore act as a discovery network wherein the CC token received by the merchant can be sent back to the third-party provider to obtain actual account detail associated with the account. The account details are may be verified by the credit card network and at operation 506 if the transaction request does not appear suspicious then process 500 can continue to operation 514, where the transaction is completed, and the payment is processed.

Alternatively, if the transaction request appears suspicious and/or information does not match, the process 500 continues to operation 508, where a user device prompts a user for a temporary CVV. As indicated above, the temporary CVV acts much like a physical credit card CVV as a form of authentication. Therefore, here a temporary CVV is request at operation 508 and received by the user via a pop-up, push, email, SMS, messaging, or other notification. The user may then input at the UI of the user device, the temporary CVV received via notification, and at operation 510 a determination is made as to whether the temporary CVV received in conjunction with the credit card token associated with the account match the user information. If indeed a match exists, then the process 500 continues to process the transaction request and payment. However, if there is a failure to match the token and/or temporary CVV, then the transaction may be blocked, and a failure presented at operation 512.

Note that process 500 may include more or less operations. Operations 502-514 and are for exemplary purposes and the order and number of operations may be modified. For example, an initial flag may not be set at operation 506 and all transaction request may require the input of a temporary CVV.

FIG. 6 is a block diagram of a networked system 600 for implementing the processes described herein, according to an embodiment. In particular, FIG. 6 illustrates a block diagram of a system 600 for obtaining a temporary CVV using tokenization rails. As shown, system 600 may include or implement a plurality of devices, computers, servers, and/or software components that operate to perform various methodologies in accordance with the described embodiments. It will be appreciated that the devices, computers, and/or servers illustrated in FIG. 6 may be deployed differently and that the operations performed and/or the services provided by such devices, computers, and/or servers may be combined or separated for a given embodiment and may be performed by a greater number or fewer number of devices, computers, and/or servers. Furthermore, one or more of the devices, computers, and/or servers may be operated and/or maintained by the same or different entities.

System 600 includes a merchant/vendor device 602, a primary user device 632, a third-party service provider computer 612 in communication over a network 650. These devices 602, 632, and 612 are exemplary devices that may interact during a transaction that may result in a failure and would necessitate the need for journaling and correction sweeping.

The merchant device 602, primary user device 632, and the third-party service provider computer 612 may each include one or more processors, memories, and other appropriate components for executing computer-executable instructions such as program code and/or data. The computer-executable instructions may be stored on one or more computer readable mediums or computer readable devices to implement the various applications, data, and steps described herein. For example, such instructions may be stored in one or more computer readable media such as memories or data storage devices internal and/or external to various components of system 600, and/or accessible over network 650.

The merchant device 602 may be implemented as a communication device that may utilize appropriate hardware and software configured for wired and/or wireless communication with the primary user device 632 and third-party service provider computer 612. For example, the merchant device 602 may be implemented as a personal computer (PC), a smart phone, laptop/tablet computer, point-of-sale device, wristwatch with appropriate computer hardware resources, eyeglasses with appropriate computer hardware, other type of wearable computing device, implantable communication devices, servers, and/or other types of computing devices capable of transmitting and/or receiving data. The merchant device 602 may correspond to and be utilized by a user, such as an employee of a merchant and/or another person authorized by the merchant, or independently as a stand-alone system.

The merchant device 602 may include one or more payment applications 604, other applications 606, a database 608, and a network interface component 610. The payment applications 604 and other applications 606 may correspond to executable processes, procedures, and/or applications with associated hardware. In other embodiments, merchant device 602 may include additional or different components having specialized hardware and/or software to perform operations associated with the payment applications 604 and/or the other applications 606.

The payment application 604 may facilitate financial transactions corresponding to the sale of goods and/or services offered by the merchant. For example, the payment application 604 may provide an interface for customers to purchase the goods or services and to receive customer payment information (e.g., customer credit card information). The payment application 604 may further transmit customer payment information to a payment processor (e.g., such as a payment processor corresponding to the third-party service provider computer 612) to process the customer payment information. The payment application 604 may also facilitate other types of financial transactions such as banking, online payments, money transfer, and/or the like.

The merchant device 602 may execute the other applications 606 to perform various other tasks and/or operations corresponding to the merchant device 602. For example, the other applications 606 may include security applications for implementing client-side security features, programmatic client applications for interfacing with appropriate application programming interfaces (APIs) over network 650, or other types of applications. In various embodiments, the other applications 606 may include social networking applications. Additionally, the other applications 606 may include device interfaces and other display modules that may receive input and/or output information. For example, the other applications 606 may include a graphical user interface (GUI) configured to provide an interface to the user.

The merchant device 602 may further include a database 608, which may be stored in a memory and/or other storage device of the merchant device 602. The database 608 may include, for example, identifiers (IDs) such as operating system registry entries, cookies associated with the payment application 604 and/or other applications 606, IDs associated with hardware of the network interface component 610, IDs used for payment/user/device authentication or identification, and/or other appropriate IDs. The database 608 may also include information corresponding to one or purchase transactions of customers who have purchased goods or services from the merchant, browsing histories of the customers, or other types of customer information. In certain embodiments, the merchant device 602 may also include information corresponding to payment tokens, such as payment tokens generated by the third-party service provider computer 612.

The merchant device 602 may also include at least one network interface component 610 configured to communicate with various other devices such as the primary user device 132, and/or the third-party service provider computer 612. In various embodiments, network interface component 610 may include a Digital Subscriber Line (DSL) modem, a Public Switched Telephone Network (PTSN) modem, an Ethernet device, a broadband device, a satellite device and/or various other types of wired and/or wireless network communication devices including microwave, radio frequency, infrared, Bluetooth®, Bluetooth low-energy, near field communication (NFC) devices, and/or the like.

The third-party service provider computer 612 may be maintained, for example, by a third-party service provider, which may provide payment processing services for the merchant. In one example, the third-party service provider may be provided by PAYPAL™ Inc. of San Jose, Calif., USA. Alternatively, the third-party service provider computer 612 may be associated with a user of the primary device 632. As such, the third-party service provider computer 612 includes one or more payment processing applications 614, which may be configured to process payment information received from the merchant device 602 or from a selection at the primary user device 632. In addition, the payment processing services can be tied to a processing system like PAPPS 106 which can aid in transaction post-processing. For example, the payment application 604 of the merchant device 602 may receive payment information from a customer to purchase a service or good offered by the merchant. Upon receipt of the payment information, the payment application 604 may transmit the payment information to the third-party service provider computer 612. The payment processing application (or third-party payment application system) 614 of the third-party service provider computer 612 may receive and process the payment information. As another example, the payment application 604 can present a payment code on a display of the user device associated with the merchant. The payment code can be scanned or transmitted to the merchant device 602 for payment processing. Still as another example, the payment processing application can present a successful transaction notification on the display of the user device when the application has been authorized and ready for post-processing.

The third-party service provider computer 612 may execute the other applications 616 to perform various other tasks and/or operations corresponding to the third-party service provider computer 612. For example, the other applications 616 may include security applications for implementing client-side security features, programmatic client applications for interfacing with appropriate APIs over the network 650, or other types of applications. The other applications 616 may also include additional communication applications, such as email, texting, voice, and IM applications that enable communication of emails, calls, texts, and other notifications through the network 650. In various embodiments, the other applications 616 may include location detection applications, such as a mapping, compass, and/or GPS applications, which may be used to determine a location of the third-party service provider computer 612. Additionally, the other applications 616 may include device interfaces and other display modules that may receive input and/or output information. For example, the other applications 616 may include a GUI configured to provide an interface to one or more users.

The third-party service provider computer 612 may further include a database 618, which may be stored in a memory and/or other storage device of the third-party service provider computer 612. The database 618 may include, for example, IDs such as operating system registry entries, cookies associated with the payment processing application 614 and/or other the applications 616, IDs associated with hardware of the network interface component 622, IDs used for payment/user/device authentication or identification, transaction IDs, and/or other appropriate IDs.

According to a particular embodiment, the third-party service provider computer 612 may include a set of payment profiles 620 corresponding to past sales transactions executed by the merchant device 102 with respect to one or more customers of the merchant. Alternatively, the third-party service provider computer 612 may include a set of merchant payment profiles corresponding to the payment sources associated to a corresponding merchant. For example, a particular payment profile from the set of payment profiles 620 may include payment information corresponding to a particular customer of the merchant and/or a merchant associated with a user. The payment information may include credit card information (e.g., encrypted card number, expiration date, security code, card issuer, and/or the like), Automated Clearing House (ACH) information (e.g., encrypted account number, routing number, and/or the like), identification information associated with the particular customer/user (e.g., a customer identifier, name, address, phone number, date of birth, and/or the like), billing information, credit score, and/or any other type of payment information associated with the particular customer. Furthermore, other payment profiles of the set of payment profiles 620 may include payment information corresponding to other customers of the merchant and/or other merchants associated with the user. In addition, the third-party service provider computer 612 may store the set of payment profiles 620 according to a first file format.

The third-party service provider computer 612 may also store a set of payment tokens corresponding to the set of payment profiles 620. For example, each payment profile of the set of payment profiles 620 may be associated with a corresponding payment token from the set of payment tokens. In some embodiments, each payment profile may include a corresponding payment token from the set of payment tokens. The set of payment tokens may be particular to the third-party service provider computer 612 (e.g., computers from other service providers may be unable to use the set of payment tokens) and may enable the merchant device 602 to more securely process payment transactions with the third-party service provider computer 612. For example, in order to process a payment transaction that involves a credit card number associated with a particular payment profile, the third-party service provider computer 612 may provide the merchant device 602 with a particular payment token that is different from the credit card number. The merchant device 602 may use the particular payment token to process the payment transaction instead of the credit card number. Further, the merchant device may store and associate the particular payment token with the particular payment profile instead of the credit card number, thereby protecting the credit card number from being stolen in a potential security breach of the merchant device 602.

In various embodiments, the third-party service provider computer 612 also includes at least one network interface component 622 that is configured to communicate with the merchant device 602, the primary user device 632, and/or the secondary user device 636 via the network 650.

The third party provider computer 612, may also include a data classification component 624 that may be used for raw data classification. In one embodiment, the raw data received by the third-party service provider computer 612 and/or stored in database 618 can be analyzed to identify errors in transaction post-processing. Additionally or alternatively, database 618 and/or classification component 624 may be communicatively coupled to PAPPS 106 for transaction record journaling, error detection, and error correction of transactions performed via the merchant device 602 and/or primary user device 632.

The primary user device 632 may be implemented as a communication device that may utilize appropriate hardware and software configured for wired and/or wireless communication with the merchant device 602 and third-party service provider computer 612. The primary user device 632, may be a personal computer (PC), a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data. In one embodiment, the primary user device 632 may be mobile device communicating with wearable device (or secondary user device), merchant device 602, or directly with the third-party service provider system 612.

The primary user device 632 may include a payment processing application 626 that may be used as a digital wallet that can communicate with a merchant device 602, a secondary user device, and/or third party service provider 612 for purchasing and transacting. The payment processing application 626, can work jointly with database 630 for retrieving bank account information, user accounts, security codes, tokens that may be associated with various merchant locations. Similarly, the payment processing application, can also provide access the user profiles for determining which payment method, processing code, to use at a merchant location.

The primary user device 632 may also include other applications 628 to perform various other tasks and/or operations corresponding to the primary user device 632. For example, the other applications 628 may facilitate communication with the merchant device 602, such as to receive an indication, from the merchant device 602, to switch payment processing services from the third-party service provider to the service provider. As another example, the other applications 628 may include security applications, application that enable designation of a primary interactive device, and applications that allow for web site searches (including access to merchant websites). The other applications 628 may also include additional communication applications, such as email, texting, voice, and IM applications that enable communication of emails, calls, texts, and other notifications through the network 650. In various embodiments, the other applications 628 may include location detection applications, such as a mapping, compass, and/or GPS applications, which may be used to determine a location of the primary user device 632. The other applications 628 may include social networking applications. Additionally, the other applications 628 may include device interfaces and other display modules that may receive input and/or output information. For example, the other applications 628 may include a GUI configured to provide an interface to one or more users.

The primary user device 632 may further include a database 630, which may be stored in a memory and/or other storage device of the primary user device 632. The database 630 may include, for example, identifiers (IDs) such as operating system registry entries, cookies associated with a web browser and/or the other applications 628, IDs associated with hardware of the network interface component 634, IDs used for payment/user/device authentication or identification, bank information, merchant information, user accounts, and/or other appropriate IDs.

The primary user device 632 may also include at least one network interface component 634 configured to communicate with various other devices such as the merchant device 602 and/or the third-party service provider computer 612.

Note that although a primary user device 632, a third-party service provider computer 612, and merchant device 602 are illustrated, a credit card provider may also be included and used in communication with the third-party service provider computer 612 and/or merchant device 602 for performing an electronic transaction. Additionally, or alternatively, the merchant may be accessed digitally through a network over a computer website on the primary user device 632 and the merchant device may instead be the credit card provider used for processing the electronic transaction. As described above and in conjunction with FIG. 3, tokenization rails associated with a credit card provider may be used for obtaining a temporary CVV which may be used for performing an electronic transaction.

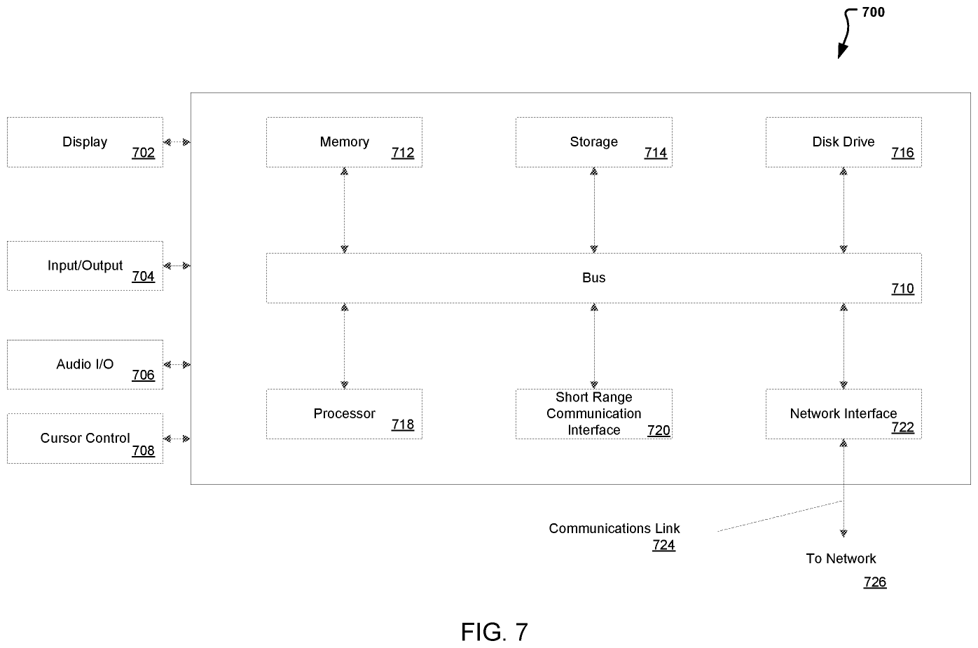

FIG. 7 illustrates an example computer system 700 in block diagram format suitable for implementing on one or more devices of the system in FIG. 1. In various implementations, a device that includes computer system 700 may comprise a computing device (e.g., a smart or mobile device, a computing tablet, a personal computer, laptop, wearable device, PDA, server, etc.) that is capable of communicating with a network 726. A service provider and/or a content provider may utilize a network computing device (e.g., a network server or third-party service provider computer 612) capable of communicating with the network 726. It should be appreciated that each of the devices utilized by users, service providers, and content providers may be implemented as computer system 700 in a manner as follows.

Additionally, as more and more devices become communication capable, such as new smart devices using wireless communication to report, track, message, relay information and so forth, these devices may be part of computer system 700. For example, windows, walls, and other objects may double as touch screen devices for users to interact with. Such devices may be incorporated with the systems discussed herein.

Computer system 700 may include a bus 710 or other communication mechanisms for communicating information data, signals, and information between various components of computer system 700. Components include an input/output (I/O) component 704 that processes a user action, such as selecting keys from a keypad/keyboard, selecting one or more buttons, links, actuatable elements, etc., and sending a corresponding signal to bus 710. I/O component 704 may also include an output component, such as a display 702 and a cursor control 708 (such as a keyboard, keypad, mouse, touchscreen, etc.). In some examples, I/O component 704 may include an image sensor for capturing images and/or video, such as a complementary metal oxide semiconductor (CMOS) image sensor, and/or the like. An audio input/output component 706 may also be included to allow a user to use voice for inputting information by converting audio signals. Audio I/O component 706 may allow the user to hear audio. A transceiver or network interface 722 transmits and receives signals between computer system 600 and other devices, such as another user device, a merchant server, an email server, application service provider, web server, a payment provider server, and/or other servers via a network. In various embodiments, such as for many cellular telephone and other mobile device embodiments, this transmission may be wireless, although other transmission mediums and methods may also be suitable. A processor 718, which may be a micro-controller, digital signal processor (DSP), or other processing component, that processes these various signals, such as for display on computer system 700 or transmission to other devices over a network 726 via a communication link 724. Again, communication link 724 may be a wireless communication in some embodiments. Processor 718 may also control transmission of information, such as cookies, IP addresses, images, and/or the like to other devices.

Components of computer system 700 also include a system memory component 714 (e.g., RAM), a static storage component 714 (e.g., ROM), and/or a disk drive 716. Computer system 700 performs specific operations by processor 718 and other components by executing one or more sequences of instructions contained in system memory component 712. Logic may be encoded in a computer readable medium, which may refer to any medium that participates in providing instructions to processor 718 for execution. Such a medium may take many forms, including but not limited to, non-volatile media, volatile media, and/or transmission media. In various implementations, non-volatile media includes optical or magnetic disks, volatile media includes dynamic memory such as system memory component 712, and transmission media includes coaxial cables, copper wire, and fiber optics, including wires that comprise bus 710. In one embodiment, the logic is encoded in a non-transitory machine-readable medium. In one example, transmission media may take the form of acoustic or light waves, such as those generated during radio wave, optical, and infrared data communications.

Some common forms of computer readable media include, for example, hard disk, magnetic tape, any other magnetic medium, CD-ROM, any other optical medium, RAM, PROM, EPROM, FLASH-EPROM, any other memory chip or cartridge, or any other medium from which a computer is adapted to read.

Components of computer system 700 may also include a short range communications interface 720. Short range communications interface 720, in various embodiments, may include transceiver circuitry, an antenna, and/or waveguide. Short range communications interface 720 may use one or more short-range wireless communication technologies, protocols, and/or standards (e.g., WiFi, Bluetooth®, Bluetooth Low Energy (BLE), infrared, NFC, etc.).

Short range communications interface 720, in various embodiments, may be configured to detect other devices (e.g., primary user device 632, merchant device 602, etc.) with short range communications technology near computer system 700. Short range communications interface 720 may create a communication area for detecting other devices with short range communication capabilities. When other devices with short range communications capabilities are placed in the communication area of short range communications interface 720, short range communications interface 720 may detect the other devices and exchange data with the other devices. Short range communications interface 720 may receive identifier data packets from the other devices when in sufficiently close proximity. The identifier data packets may include one or more identifiers, which may be operating system registry entries, cookies associated with an application, identifiers associated with hardware of the other device, and/or various other appropriate identifiers.

In some embodiments, short range communications interface 720 may identify a local area network using a short range communications protocol, such as WiFi, and join the local area network. In some examples, computer system 700 may discover and/or communicate with other devices that are a part of the local area network using short range communications interface 720. In some embodiments, short range communications interface 720 may further exchange data and information with the other devices that are communicatively coupled with short range communications interface 720.

In various embodiments of the present disclosure, execution of instruction sequences to practice the present disclosure may be performed by computer system 700. In various other embodiments of the present disclosure, a plurality of computer systems 700 coupled by communication link 724 to the network (e.g., such as a LAN, WLAN, PTSN, and/or various other wired or wireless networks, including telecommunications, mobile, and cellular phone networks) may perform instruction sequences to practice the present disclosure in coordination with one another. Modules described herein may be embodied in one or more computer readable media or be in communication with one or more processors to execute or process the techniques and algorithms described herein.

A computer system may transmit and receive messages, data, information and instructions, including one or more programs (i.e., application code) through a communication link 724 and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable media. It is also contemplated that software identified herein may be implemented using one or more computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants/vendors and customers; however, a customer or consumer can pay, or otherwise interact with any type of recipient, including charities and individuals. Thus, “merchant” as used herein can also include charities, individuals, and any other entity or person receiving a payment from a customer. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A third-party application system, comprising:
a non-transitory memory storing instructions;
a processor configured to execute the instructions to cause the system to:
receive, from an entity, a request to process an electronic transaction by the third-party application system;
transmit, in response to the request, a token associated with an account information of a user, the account information accessed based on a login input by the user at the third-party application system;
determine, the request satisfies a criteria and transmit a request to enter a temporary CVV code;
process, the request, based in part on the temporary CVV received and token transmitted.

2. The third-party application system of claim 1, wherein in response to transmitting the token associated with the account information of the user, a credit card network transmitting the token to the third-party payment application system to obtain the user account information of the user.

3. The third-party application system of claim 1, wherein temporary CVV code is generated by a credit card network using tokenization rails.

4. The third-party application system of claim 1, wherein in processing the request, the third-party payment application system verifies and determines is the token associated with the account information and the temporary CVV match a user account.

5. The third-party application system of claim 4, where a credit card network transmits the token associated with the account information and the temporary CVV to the third-party payment application system for the verification.

6. The third-party application system of claim 1, wherein the temporary CVV is transmitted to a user device of the user via an email notification.

7. The third-party application system of claim 1, wherein the token associated with the account is a random number replacing the personal account number.

8. The third-party application system of claim 1, wherein the temporary CVV is a randomly generated three-digit number.

9. A method, comprising:
receiving, from a product provider entity, a request to process an electronic transaction by the third-party application system;
transmit, in response to the request, a token associated with an account information of a user, the account information accessed based on a login input by the user at the third-party application system;
determine, the request received meets a criteria and transmit a request to enter a temporary CVV code;
process, the request, based in part on the temporary CVV received and token transmitted.

10. The method of claim 9, wherein in response to transmitting the token associated with the account information of the user, a credit card network transmitting the token to the third-party application system to obtain the user account information of the user.

11. The method of claim 9, wherein temporary CVV code is generated by a credit card network using tokenization rails.

12. The method of claim 9, wherein in processing the request, the third-party application system verifies and determines is the token associated with the account information and the temporary CVV match a user account.

13. The method of claim 12, where a credit card network transmits the token associated with the account information and the temporary CVV to the third-party application system for the verification.

14. The method of claim 9, wherein the temporary CVV is transmitted to a user device of the user via an email notification.

15. The method of claim 9, wherein the token associated with the account is a random number replacing the personal account number.

16. A non-transitory machine-readable medium having instructions stored thereon, the instructions executable to cause performance of operations comprising:
receiving, from a product provider entity, a request to process an electronic transaction by the third-party payment application system;
transmitting, in response to the request, a token associated with an account information of a user, the account information accessed based on a login input by the user at the third-party payment application system;
determining, the request received meets a criteria and transmit a request to enter a temporary CVV code;
processing, the request, based in part on the temporary CVV received and token transmitted.

17. The non-transitory machine-readable medium of claim 16, wherein in response to transmitting the token associated with the account information of the user, a credit card network transmitting the token to the third-party payment application system to obtain the user account information of the user.

18. The non-transitory machine-readable medium of claim 16, wherein temporary CVV code is generated by a credit card network using tokenization rails.

19. The non-transitory machine-readable medium of claim 16, wherein in processing the request, the third-party payment application system verifies and determines is the token associated with the account information and the temporary CVV match a user account.

20. The non-transitory machine-readable medium of claim 16, where a credit card network transmits the token associated with the account information and the temporary CVV to the third-party payment application system for the verification.
